(19) United States
(12) Patent Application Publication
(10) Pub. No.: US 2013/0098826 A1
(43) Pub. Date: Apr. 25, 2013

(54) Treatment Unit for Treating a Cooling Fluid of a Cooling Device of a Functional System

(71) Applicant: MANN+HUMMEL GMBH, Ludwigsburg (DE)

(72) Inventors: Andreas Kloz, Bietigheim-Bissingen (DE); Volker Kuemmerling, Sachsenheim (DE); Juergen Stahl, Kornwestheim (DE); Michael Fasold, Auenwald (DE); Andreas Epp, Marbach (DE); Markus Beylich, Ludwigsburg (DE); Detlef Klein, Marbach (DE); Peter Thurn, Bietigheim (DE)

(73) Assignee: MANN+HUMMEL GMBH, Ludwigsburg (DE)

(21) Appl. No.: 13/656,683

(22) Filed: Oct. 20, 2012

(30) Foreign Application Priority Data
Oct. 21, 2011 (DE) 102011116568.5

(51) Int. Cl. B01J 47/06

(52) U.S. Cl. CPC B01J 47/06
USPC 210/287

(57) ABSTRACT

A treatment unit for treating a cooling fluid of a cooling device of a functional system has a container provided with at least one inlet and at least one outlet. A granular ion-exchange medium is arranged in the container in a flow path of the cooling fluid to be treated flowing from the at least one inlet to the at least one outlet. A compression device is arranged in the container and compresses the granular ion-exchange material. The compression device has at least one elastic porous compression element that is permeable for the cooling fluid and is arranged in the flow path between the inlet and the outlet so that the cooling fluid passes through the at least one compression element. The compression element is an open-cell foam material element.

### CROSS REFERENCE TO RELATED APPLICATIONS

This application claims the benefit of prior filed German patent application no. DE 10 2011 116 568.5, filed in Germany on Oct. 21, 2011, the entire contents of which are incorporated herein by reference.

### BACKGROUND OF THE INVENTION

The invention concerns a treatment unit, in particular an ion exchanger, for treating a cooling fluid of a cooling device of a functional system, in particular of a fuel cell system, in particular of a motor vehicle, comprising a container that has at least one inlet for cooling fluid to be treated and at least one outlet for the treated cooling fluid. In the container, in a flow path of the cooling fluid between the inlet and the outlet, a granular ion-exchange medium is disposed. A compression device for compressing the ion-exchange medium is provided.

DE 10 2009 037 080 A1 discloses an ion-exchange cartridge for treatment of a cooling fluid of a cooling circuit of a fuel cell system of a motor vehicle. The ion-exchange cartridge has an enclosure provided in the upper area with outflow openings for the cooling fluid. The cartridge bottom of the ion-exchange cartridge has inflow openings through which the cooling fluid can flow into the interior of the ion-exchange cartridge. The ion-exchange cartridge is filled with granular ion-exchange material. The cooling fluid must flow through the granular ion-exchange material from the bottom to the top, i.e., from the inflow openings to the outflow openings and is treated along the way. On the inner side of the cartridge cover that is facing the interior of the ion-exchange cartridge, a compression plate is attached by means of an elastic bellows that is approximately hollow-cylindrical. A spiral compression spring is supported with its ends at the inner side of the cartridge cover and at the side of the compression plate that is facing the cartridge cover. The compression device, comprising the cartridge cover, the compression plate, and the spiral compression spring, has the effect that a compression of the granular ion-exchange material is automatically readjusted as soon as, for example, the granular ion-exchange material settles. The spring compartment in which the spiral compression spring is disposed is seal-tightly closed relative to the interior of the ion-exchange cartridge so that no cooling fluid can enter the spring compartment. The compression device is located outside of the flow path of the cooling fluid through the ion-exchange cartridge. The compression device has exclusively the function to compress the ion-exchange medium.

It is an object of the present invention to configure a treatment unit of the aforementioned kind that is if a simple and more compact configuration, that enables an efficient treatment of the cooling fluid, and that can counteract positive and negative volume changes of the ion-exchange medium relative to the container in a reliable way.

### SUMMARY OF THE INVENTION

In accordance with the present invention, this is achieved in that the compression device has at least one elastic porous compression element, preferably an open-cell foam material element, that is disposed in the flow path between the inlet and the outlet so that the cooling fluid flows through the compression element.

According to the invention, an elastic porous compression element is thus provided which has shape-stable properties and exhibits a distinct elasticity so that it simply adjusts to positive or negative volume changes of the ion-exchange medium and maintains the ion-exchange medium always in a compact form. Preferably, the compression element can be an open-cell foam material element. The compression element exerts a compression function in the manner of a compression spring. A volume decrease of the ion-exchange medium can be caused in particular by cooling medium components which can chemically attack and dissolve the grains of the ion-exchange medium. With the elastic compression element it is also possible to compensate swelling of the ion-exchange medium in the container, in particular caused by cooling medium absorption into the ion-exchange medium and/or thermal expansion. With the compression element it is also possible to counteract simply and efficiently an increase of the packing density or filling density in particular as a result of frost effects. Also, fluctuations of the operating pressure of the cooling fluid in the container can be compensated. Because of the volume compensation with the elastic compression element, damages of the ion-exchange medium, in particular by formation of cracks in the walls of the container or at connecting locations between walls can be prevented. This has a positive effect on operational safety of the treatment unit, in particular seal-tightness of the container. Since the compression element maintains the compactness of the ion-exchange medium, the container can be almost completely filled with ion-exchange material. In this way, the exchange capacity of the treatment unit is increased. Moreover, the compression of the ion-exchange medium prevents that the cooling medium will generate preferred flow paths through the ion-exchange medium. The cooling medium, as it passes through, is forced to distribute uniformly within the ion-exchange medium so that the ion-exchange medium is completely flowed through and all grains or beads are uniformly contacted by the cooling medium. Accordingly, the service life of the ion-exchanger can be increased.

The compression prevents also that the granular material of the ion-exchange medium can move freely within the container which may cause wear and an increase in rubbed-off particles of the grains. The rubbed -off particles may cause a volume decrease of the ion-exchange medium. Moreover, the rubbed-off particles may cause increased pressure loss in the treatment unit. In particular, the rubbed-off particles may clog fluid passages in the treatment unit. By reducing wear, the service life of the treatment unit, in particular of the ion-exchange medium, can be increased.

The elastic compression element moreover can contribute to damping of possibly occurring vibrations of the container. In this way, damage of the treatment unit as a result of vibrations can be counteracted. The expenditure for additional damping means can be reduced. This has a positive effect on the assembly expenditure, material expenditure, required space, and weight.

The compression element that can be flowed through by the cooling fluid because of its open-cell structure is arranged within the flow path. The compression element can effect a distribution of the cooling fluid across the flow cross-section like a diffusor. With the compression element the flow conditions in the ion-exchange medium can be improved, in particular made more uniform, and, in this way, the ion-exchange efficiency and the ion-exchange capacity can be optimally utilized. Advantageously, the pores of the open-cell compression element can be smaller than the smallest grains or beads of the ion-exchange medium so that the grains or beads can be retained by the foam material element. In this way, a separate retaining element, in particular retaining plates, for the ion-exchange medium are not needed. This has a positive effect on material expenditure, assembly expenditure, and weight.

The compression element can additionally act as a filter for the cooling fluid with which particles possibly contained in the cooling fluid, in particular dirt particles and/or rubbed-off particles of components of the cooling system, can be filtered out. The compression element can therefore also be configured as a filter element. Advantageously, the pore size of the open-cell foam material element can be smaller than the smallest particles in the cooling fluid. Preferably, the compression element can be made of a material which, relative to the cooling medium, is stable thermally as well as chemically. In this way, the service life of the compression element can be extended.

In an advantageous embodiment, the compression element can have a cross-section that covers the entire flow cross-section of the ion-exchange medium, in particular can be flowed through uniformly. In this way, the flow within the ion-exchange medium and thus the ion-exchange efficiency and ion-exchange capacity are improved. As a whole, a pressure loss in the container of the treatment unit can be reduced in this way. When the compression element is arranged upstream of the ion-exchange medium, the cooling fluid passing through can be distributed uniformly across the entire cross-section of the ion-exchange medium. When the compression element is arranged downstream of the ion-exchange medium, the treated cooling fluid from the ion-exchange medium can flow uniformly across the entire flow cross-section out of the ion-exchange medium and flow toward the compression element.

Advantageously, the compression element can be made of polyurethane or another polymer based on a thermoplastic polymer or a thermoset polymer. Based on these materials, an open-cell compression element of plastic material can be realized that is permeable for fluid. Moreover, with these materials the compression element can be optimally designed with regard to the cooling fluid with respect to elasticity, shape stability, thermal stability, and chemical stability. Moreover, these materials can be processed in a simple way.

Advantageously, the compression element can be arranged in a pre-tensioned state within the container. The pretension of the foam material element has the effect that the ion-exchange medium, even in particular in the rest state, remains in compressed form or can be compressed better. With the pretensioned compression element, a volume decrease of the ion-exchange medium can also be compensated better. Moreover, the compression element can be retained stably within the container. Moreover, with the pretensioned compression element also tolerances of the filling level of the ion-exchange medium in the container can be compensated. In this way, also component tolerances of the container can be compensated in a simple way. In particular, the manufacture of the container by an injection molding process can thus be simplified.

Advantageously, the compression element can be arranged with pretension in the container in radial and/or axial direction relative to the flow path. With pretension in radial direction, the compression element can be pressed seal-tightly against an appropriate circumferential side of the container. Accordingly, the cooling fluid cannot flow past (bypass) the compression element. By means of pretension in axial direction, the ion-exchange medium can be compressed in a simple way.

In a further advantageous embodiment, the container can be cylindrical or conical. In particular, the container can have a draft angle. Advantageously, an axis of the container can extend along the flow path. A cylindrical container can be mounted simply and constructed in a space-saving way. It can be filled easily with ion-exchange medium and provided with the compression device, in particular the compression element. In a cylindrical container, it is possible in a simple way to provide a uniform flow cross-section in the flow direction. In this way, a uniform loading of the ion-exchange medium can be achieved. Accordingly, the service life of the ion-exchange medium and the service life of the treatment unit can be extended. Moreover, with a cylindrical configuration an optimal ratio between size and ion-exchange capacity can be realized.

Advantageously, the compression element can have a cylindrical or conical shape. A conical or cylindrical compression element can be supported directly on an end face of a cylindrical container so that no separate support device, in particular a fluid-permeable retaining wall, in particular in the form of a frit, is required. A cylindrical shape has the advantage that the compression element is resting uniformly and seal-tightly at the inner wall of the cylindrical container. With a conical compression element, moreover, a gradient structure along the flow direction of the cooling fluid can be created by means of which, with one-sided compression of the compression element, a predetermined flow state, in particular a predetermined flow course with a flow velocity that varies across the length of the compression element, can be predetermined in combination with a predetermined pressure loss in the container.

Moreover, advantageously at least one compression element can be arranged between the inlet and the ion-exchange medium and/or at least one compression element between the ion-exchange medium and the outlet. A compression element that is arranged upstream of the ion-exchange medium can additionally act as a filter in order to protect the ion-exchange medium from particles that may be contained in the cooling medium. In addition, or alternatively, a foam material element can be arranged downstream of the ion-exchange medium. With this compression element, the grains or beads of the ion-exchange medium can be retained. Inasmuch as on both ends of the ion-exchange medium a compression element is arranged, the ion-exchange medium arranged therebetween can be compressed even better at both ends, in particular more uniformly. Moreover, in this way an improved damping action against vibration can be achieved.

According to a further advantageous embodiment, the compression element can be supported immediately on the ion-exchange medium. In this way, a separate fluid-permeable retaining plate for the grains of the ion-exchange medium is not needed and can be eliminated. The surface of the compression element can adapt flexibly to the surface of the ion-exchange medium. The compression element can advantageously be supported on the side that is facing away from the ion-exchange medium on a fluid-permeable plate. This fluid-permeable plate can assume in particular the function of a prefilter whose fluid openings can have a greater diameter than the pores of the compression element. In this way, larger particles that may be contained in the cooling fluid can be retained at the fluid-permeable plate so that they will not reach the compression element. The service life of the compression element and thus the service life of the ion-exchanger can be increased in a simple way by this measure.

### BRIEF DESCRIPTION OF THE DRAWING

Further advantages, features, and details of the invention can be taken from the following description in which embodiments of the invention will be explained in more detail with the aid of the drawing. A person of skill in the art will consider the features disclosed in combination in the drawing, the description, and the claims also expediently individually and will combine them to other meaningful combinations.

FIG. 1 shows schematically a partial longitudinal section view of a first embodiment of an ion-exchanger of a cooling circuit of a fuel cell system of a motor vehicle with a foamed material element for compression of a granular ion-exchange material;

FIG. 2 shows a simplified longitudinal section of an ion-exchange cartridge according to a second embodiment which is similar to the ion-exchange cartridge of FIG. 1; and

FIG. 3 shows a simplified longitudinal section of a third embodiment of an ion-exchange cartridge which is similar to the ion-exchange cartridge of FIGS. 1 and 2 wherein two elastic foamed material elements are provided here at both ends of the granular ion exchange material.

In the Figures, same components are identified with the same reference characters.

### DESCRIPTION OF THE PREFERRED EMBODIMENTS

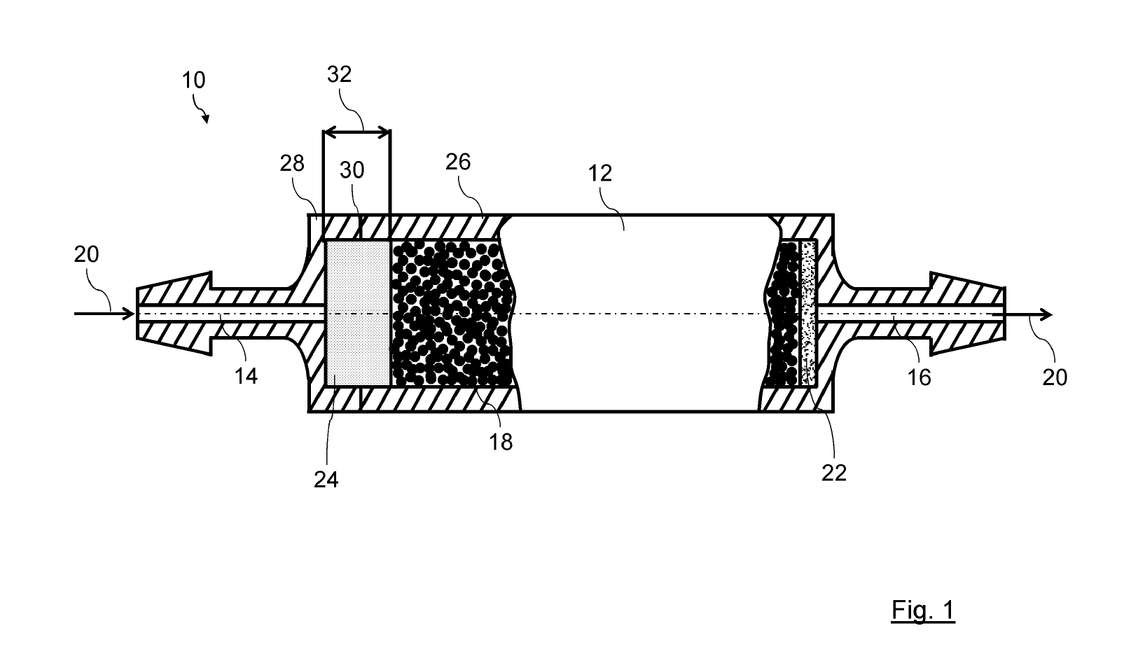

In FIG. 1, a first embodiment of an ion-exchange cartridge 10 is illustrated which is arranged within a cooling circuit, not illustrated, of a fuel cell system of a motor vehicle. The cooling circuit serves, in a way that is not of interest in this context, to dissipate the heat that is produced in the fuel cell system. The cooling medium that is used for the heat transport is in contact with a radiator and other components of the cooling system so that it contains positively and/or negatively charged ions. In this way, an electrical conductivity of the cooling medium can be generated. In order to prevent a reduction of the power output or damage to the fuel cell system, for example, by short-circuiting, the cooling medium is passed through the ion-exchanger 10. By treatment within the ion exchanger 10, a predetermined limit of conductance of the cooling agent can be maintained.

The ion-exchange cartridge 10 comprises a housing 12 of a circular cylindrical shape that has at one end face an inlet 14 for the cooling medium to be treated and at the other end face an outlet 16 for the treated cooling medium. The inlet 14 is connected with an inlet conduit, not illustrated, of the cooling circuit and the outlet 16 with an outlet conduit, not illustrated, of the cooling circuit.

In the housing 12, a granular ion-exchange material 18 is arranged. The granular ion-exchange material 18 is comprised of granular anion-exchange resin for negatively charged ions and a granular cation-exchange resin for positively charged ions. The anion-exchange resin and the cation-exchange resin are present in a predetermined mixing ratio, not of interest in this context. The grain size (bead size) of the granular ion-exchange material 18 is preferably in a range of 0.4 mm to 1.2 mm. Smaller or larger grain (bead) sizes are possible also. The grains of the ion-exchange material 18 are loosely disposed, i.e., they are not connected to each other, within the housing 12.

The flow path of the cooling medium through the ion-exchange cartridge 10 is indicated by arrows 20. Downstream of the granular ion-exchange material 18, between the granular ion-exchange material 18 and a downstream end wall of the housing 12, a fluid-permeable retaining plate 22 is arranged. The retaining plate 22 is comprised of a sintered material, for example, glass, plastic or metal. The retaining plate 22 has a defined pore size. The pores are smaller than the smallest grain size of the granular ion-exchange material 18. By means of the retaining plate 22, it is prevented that the grains of the granular ion-exchange material 18 can reach the outlet 16.

In the flow path 20 between the inlet 14 and the granular ion-exchange material 18, a porous compression element in the form of an elastic circular cylinder-shaped foam material element 24 is arranged. The foam material element 24 is made of an open-cell foam material, for example, a polyurethane foam with a homogenous cell structure. The foam material element 24 is supported with an end face on the upstream end wall of the housing 12 that is facing the inlet 14. The other end face of the foam material element 24 is supported on the granular ion-exchange material 18. The foam material element 24 extends across the entire cross-section of the housing 12 that is filled by the granular ion-exchange material 18. The foam material element 24, relative to an axis of the housing 12, is pretensioned in axial direction so that it compresses the granular ion-exchange material 18 in axial direction. The granular ion-exchange material 18 is thus retained in compact form. Moreover, the foam material element 24 is pretensioned in a radial direction so that the radial outer circumferential side of the foam material element 24 is pressed seal-tightly against the radial inner circumferential side of the housing 12. In this way, it is prevented that cooling medium entering the housing 12 through the inlet 14 can bypass the foam material element at the radial outer side.

The pore size of the foam material element 24 is smaller than the smallest grain size of the granular ion-exchange material 18. The foam material element 24 retains in this way the grains of the granular ion-exchange material 18 and prevents that they can pass into the inlet 14. The pore size of the foam material element 24 is moreover smaller than the particles contained possibly in the cooling medium, for example, dirt particles and/or rubbed-off particles of components of the cooling circuit. The foam material element 24, the granular ion-exchange material 18, and the retaining plate 22 are positioned within the flow path 20 of the cooling medium to be treated. The cooling medium is therefore forced to pass through them.

For producing the ion-exchange cartridge 10, a housing pot 26 which comprises the outlet 16 and a housing cover 28 which comprises the inlet 14 are produced.

The retaining plate 22 is inserted into the housing pot 26 such that it is resting against the inside of the downstream end wall. Subsequently, the granular ion-exchange material 18 is filled into the housing pot 26. In this connection, the housing pot 26 is almost completely filled.

The foam material element 24 is radially compressed and is inserted into the open side of the housing pot 26 so that it is resting tightly against the end face of the granular ion-exchange material 18. The original diameter of the relaxed foam material element 24 is greater than the inner diameter of the housing pot 26 and of the housing cover 28. The radial pretensioned foam material element 24 is positioned also seal-tightly on the radial inner circumferential side of the housing pot 26.

Subsequently, the housing cover 28 is arranged on the open side of the housing pot 26 and attached thereto with a weld seam 30. The spacing 32 between the inner side of the end wall of the housing cover 26 and the end face of the granular ion-exchange material 18 that is facing the housing cover 28 is smaller than the axial dimension of the foam material element 24 in the relaxed state so that, when the ion-exchange cartridge 10 is in the assembled state, the foam material element 24 is arranged with pretension in the housing 12. This pretension effects a compression of the granular ion-exchange material 18.

When operating the cooling circuit, the cooling medium is supplied in the direction of the flow path 20 to the inlet 14. From here, the cooling medium flows through the end wall of the housing cover 28 and reaches the foam material element 24. In the foam material element 24 the cooling medium is uniformly distributed across the entire cross-section of the housing 12 and exits, distributed across a large surface area, at the end face of the foam material element 24 that is facing the granular ion-exchange material 18. The foam material element 24 acts thus like a diffusor.

In the foam material element 24, particles possibly contained in the cooling medium are also filtered out and are thus kept way from the granular ion-exchange material 18. The prefiltered cooling medium flows, distributed across the entire cross section of the housing 12, into the granular ion-exchange material 18. It must pass through the granular ion-exchange material 18 uniformly across the entire cross section; treatment of the cooling medium is realized therein in a way not of interest here. The pretensioned foam material element 24 counteracts the generation of preferred flow passages within the granular ion-exchange material 18.

The treated cooling medium flows through the retaining plate 22 where the granular ion-exchange material 18 is retained and reaches the outlet 16. From here, it exits the ion-exchange cartridge 10 in the form of as treated cooling medium.

By means of the foam material element 24, vibrations of the ion-exchange cartridge 10 that are possibly occurring, e.g. caused by operation, are dampened also.

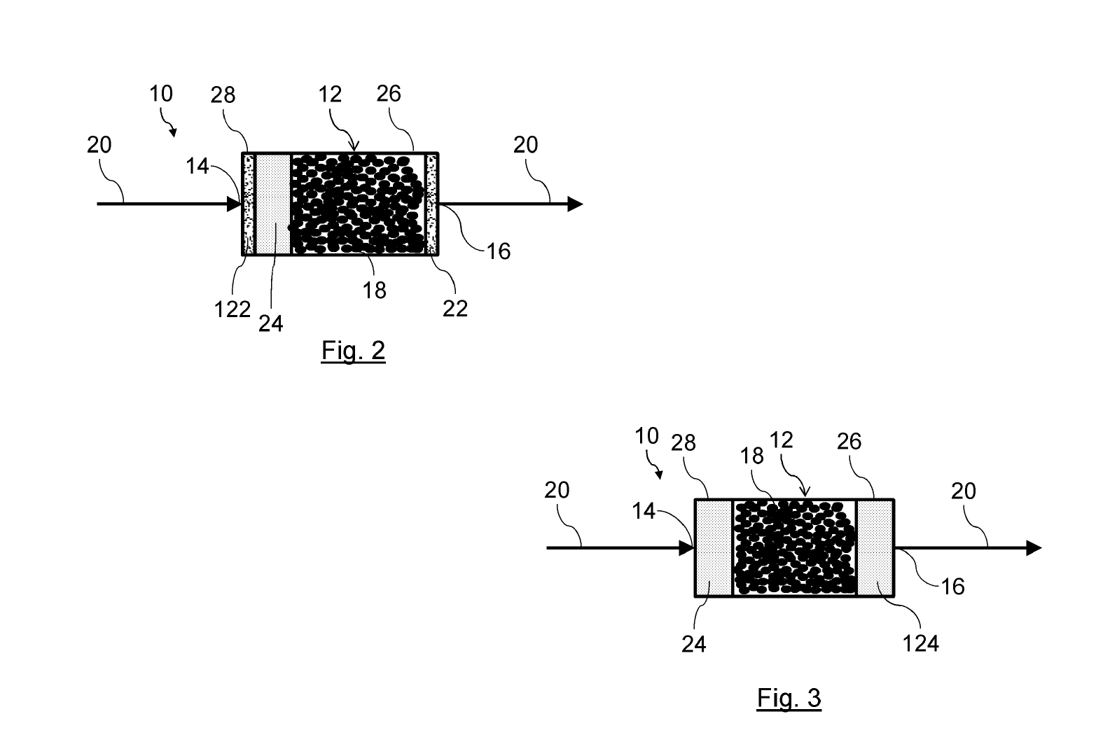

In FIG. 2, a second embodiment of an ion-exchange cartridge 10 is illustrated in a simplified way. Those elements that are similar to those of the first embodiment of FIG. 1 are identified with the same reference characters. In contrast to the first embodiment, in the second embodiment of FIG. 2 in the flow path 20 between the inlet 14 and the foam material element 24 a second retaining plate 122 is arranged that is permeable for the cooling medium. The second retaining plate 122 can be comprised of the same material as the first retaining plate 22. However, it can also be of a different type of fluid-permeable material. Its pore size can be greater than the pore size of the retaining plate 22. Advantageously, the pore size of the retaining plate 122 can be greater than the pore size of the foam material element 24. In this way, the retaining plate 122 can serve as a prefilter where possibly larger particles of the cooling medium can be filtered out so that they do not reach the foam material element 24. In this way, premature soiling of the foam material element 24 is prevented which, as a whole, increases the service life of the ion-exchange cartridge 10.

In FIG. 3, a third embodiment of an ion-exchange cartridge 10 is illustrated. Those elements that are similar to those of the first embodiment of FIG. 1 are identified with the same reference characters. The third embodiment of FIG. 3 differs from the first embodiment of FIG. 1 in that instead of the retaining plate 22 a second foam material element 124 is arranged fluidically between the granular ion-exchange material 18 and the outlet 16. The foam material element 124 is of the same material as the foam material element 24. It also has the same shape and size. In analogy to the foam element 24, it is pretensioned in axial direction and in radial direction so that it pushes axially against the granular ion-exchange material 18 and rests seal-tightly on the radial inner circumferential wall of the housing 12. The granular ion-exchange material 18 is thus compressed in axial direction at both end faces. The two foam material elements 24 and 124 provide additionally improved damping against possibly operationally caused vibrations of the ion-exchange cartridge 10.

In all of the above described embodiments of an ion-exchange cartridge 10, the following modifications are possible inter alia.

The invention is not limited to an ion-exchange cartridge 10 of a cooling device of a fuel cell system. Instead, it can also be used in cooling devices of different types of functional systems. It can also be used in a combined filtering system with ion-exchanger. Also, the invention is not limited to motor vehicles. Instead, it can also be used in other functional systems outside of the field of automotive technology. The invention can be used also in different kinds of deionization filters for mobile or stationary applications.

Instead of the retaining plate 22; 122 of sintered material, also a retaining plate of a different kind that is permeable for liquid media can be used. For example, a nonwoven can be employed also that is arranged on a support frame.

The foam material element 24, 124, instead of having a homogenous cell structure, can also have an inhomogeneous cell structure.

Instead of the foam material elements 24, 124, also other types of elastic porous compression elements, for example, filter elements can be provided.

Instead of being made of polyurethane, the foam material element 24, 124 can be made of a different kind of open cell foam material, for example, a plastic material, preferably a polymer based on thermoplastic material or thermosetting material.

The foam material element 24, 124, instead of having a cylindrical shape, can also be shaped differently, for example can have a conical shape or another shape. In this way, by one-sided compression of the respective foam material element 24, 124 a flow state and/or a defined pressure loss within the ion-exchange cartridge 10 can be predetermined. The foam material elements 24, 124, instead of having a round base surface, can also have a different base surface, for example an oval or polygonal one.

The housing 12, instead of having a circular cylindrical base surface, can also be shaped differently, for example, cylindrical with a different base surface, for example, polygonal or oval, or can be conical. Advantageously, the profile of the foam material element 24, 124 can be similar to the profile of the housing.

The inlet 14, instead of being provided at the housing cover 28, can also be arranged at the housing pot 26. Accordingly, the outlet 16 is then arranged at the housing cover 28.

It is also possible to provide more than one inlet 14 and/or more than one outlet 16. In the third embodiment of FIG. 3, the foam material element 124, instead of being made of the same material as the foam material element 24, can also be made of a different elastic open-cell foam material. The foam material element 124 can have a smaller or greater pore size than the foam material element 24. The pore size of the foam material element 24 can be preferably smaller than the smallest grain size of the granular ion-exchange material 18 so that the foam material element 124 at the same time can also retain the granular ion-exchange material 18. The foam material element 24 can also have different shape and/or size.

While specific embodiments of the invention have been shown and described in detail to illustrate the inventive principles, it will be understood that the invention may be embodied otherwise without departing from such principles.

What is claimed is:

1. A treatment unit for treating a cooling fluid of a cooling device of a functional system, the treatment unit comprising:
a container provided with at least one inlet and at least one outlet;
a granular ion-exchange medium arranged in the container in a flow path of a cooling fluid to be treated flowing from the at least one inlet to the at least one outlet;
a compression device arranged in the container and adapted to compress the granular ion-exchange material;
the compression device comprising at least one elastic porous compression element that is permeable for the cooling fluid and is arranged in the flow path between the at least one inlet and the at least one outlet so that the cooling fluid passes through the at least one compression element.

2. The treatment unit according to claim 1, wherein the at least one compression element is an open-cell foam material element.

3. The treatment unit according to claim 1, wherein the at least one compression element has a cross-section that covers an entire flow cross-section of the granular ion-exchange medium.

4. The treatment unit according to claim 3, wherein the cross-section of the at least one compression element is configured to enable uniform flow of the cooling fluid through the at least one compression element.

5. The treatment unit according to claim 1, wherein the at least one compression element is made of polyurethane.

6. The treatment unit according to claim 1, wherein the at least one compression element is made of a thermoplastic polymer.

7. The treatment unit according to claim 1, wherein the at least one compression element is made of a thermosetting polymer.

8. The treatment unit according to claim 1, wherein the at least one compression element is arranged in a pretensioned state in the container.

9. The treatment unit according to claim 8, wherein the at least one compression element is pretensioned in a radial direction relative to the flow path within the container.

10. The treatment unit according to claim 8, wherein the at least one compression element is pretensioned in an axial direction relative to the flow path within the container.

11. The treatment unit according to claim 8, wherein the at least one compression element is pretensioned in an axial direction and a radial direction relative to the flow path within the container.

12. The treatment unit according to claim 1, wherein the container is cylindrical or conical.

13. The treatment unit according to claim 1, wherein the compression element has a cylindrical shape or a conical shape.

14. The treatment unit according to claim 1, wherein the at least one compression element is arranged between the at least one inlet and the granular ion-exchange medium.

15. The treatment unit according to claim 1, wherein the at least one compression element is arranged between the granular ion-exchange medium and the at least one outlet.

16. The treatment unit according to claim 1, wherein a first and a second one of the at least one compression element are provided, wherein the first one is arranged between the at least one inlet and the granular ion-exchange medium and the second one is arranged between the granular ion-exchange medium and the at least one outlet.

17. The treatment unit according to claim 1, wherein the at least one compression element is supported immediately on the ion-exchange medium.
